(19) United States
(12) Patent Application Publication
(10) Pub. No.: US 2008/0240801 A1
(43) Pub. Date: Oct. 2, 2008

(54) Transfer Apparatus, Image Forming Apparatus Having the Same and Image Forming Method

(75) Inventor: Satoshi Chiba, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/052,437

(22) Filed: Mar. 20, 2008

(30) Foreign Application Priority Data
Mar. 26, 2007 (JP) 2007-079135
Mar. 26, 2007 (JP) 2007-079136

(51) Int. Cl. G03G 15/14

(52) U.S. Cl. 399/308

(57) ABSTRACT

A transfer apparatus can uniformize the charged amount of toner on the intermediate transfer member and ensure a uniform transfer performance over the entire printing surface by means of a simple arrangement. The transfer apparatus has a primary transfer means arranged corresponding to a plurality of image carriers in order to primarily transfer the toner images on the image carriers, an intermediate transfer member adapted to operate for color superposition by the primary transfer means, a secondary transfer means adapted to operate for secondary transfer of the toner image on the intermediate transfer member onto a transfer medium and a pre-secondary transfer charging means for electrically charging the pre-secondary transfer toner on the secondary transfer means with the opposite polarity, the secondary transfer means being adapted to apply a secondary transfer bias to the toner on the intermediate transfer member with the polarity opposite to that of the primary transfer bias applied at the time of primary transfer.

### CROSS REFERENCES TO RELATED APPLICATIONS

The present invention contains subject matter related to Japanese Patent Application JP 2007-79135 and Japanese Patent Application JP 2007-79136 filed in the Japanese Patent Office both on Mar. 26, 2007, the entire contents of which are incorporated herein by reference.

### BACKGROUND OF THE INVENTION

1. Field of the Invention

This invention relates to a transfer apparatus to be used in a printer, a facsimile machine or a copying machine for forming an image on a recording medium such as a sheet of paper by means of electrophotography and an image forming apparatus having the same.

2. Description of the Related Art

Conventionally, in an electrophotographic image forming apparatus, transfer apparatus for transferring one or more toner images formed on one or more image carriers, whichever appropriate, and electrically charged to a predetermined polarity onto an intermediate transfer member for primary transfer, utilizing electrostatic force, and then transferring the toner images on the intermediate transfer member to a transfer medium such as a sheet of paper for secondary transfer, also utilizing electrostatic force, are known. Transfer apparatus employing an intermediate transfer member are being popularly used in color image forming apparatus because it can sequentially transfer toner images formed on respective image carriers onto the intermediate transfer member so as to lay them one on the other.

Normally, toner is electrically charged by means of a developing unit and a toner image is transferred with the same polarity of electrification for both primary transfer and secondary transfer. To do this, an electric charge with the polarity opposite to the polarity of electrification of toner is conventionally applied for the transfer to the intermediate transfer member and also to a transfer medium such as a sheet of paper. In other words, the polarity of the bias of primary transfer is same as that of the bias of secondary transfer.

Transfer methods of charging the transfer medium with the polarity opposite to that of toner in order to support the secondary transfer performance of toner are known (see, for example, JP-B 3517621).

Transfer apparatus having a scorotron type charge eliminating means arranged upstream relative to the intermediate transfer member operating for secondary transfer and adapted to apply a DC voltage to the discharge electrode of the charge eliminator with the polarity opposite to that of toner so as to reduce the electric charge of the toner layer and improve the transfer performance of secondary transfer are known (see, for example, JP-A 2006-243333).

Transfer apparatus having a pre-secondary transfer charging means and adapted to control the output of the pre-secondary transfer charging means in order to maintain the difference between the electric potential of the toner image on the intermediate transfer member and the electric potential of the secondary transfer means for secondarily transferring the toner image onto a transfer medium are known (see, for example, JP-B 3718045).

Furthermore, transfer apparatus having an intermediate transfer member of a multilayer structure including a conductive layer in order to improve the transfer performance are known (see, for example, JP-A 2006-47491).

### SUMMARY OF THE INVENTION

The charged amount of the toner on the intermediate transfer member changes when it passes through a plurality of image carriers for the purpose of superposing colors. The charged amount of the toner on the intermediate transfer member changes remarkably to give rise to a problem that the fluctuations of the charged amount of the toner on the intermediate transfer member become remarkable to make it no longer possible to secure a uniform transfer performance on the entire printing surface when the particle size of toner is decreased to improve the image quality and/or when the pigment concentration in toner is raised to reduce the amount of the toner on the intermediate transfer member.

When the transfer medium is charged with the opposite polarity in advance as described in JP-B 3517621, the pre-transfer starts immediately before the nip for the secondary transfer to give rise to a problem of a distorted toner image.

When the charged amount of the toner on the intermediate transfer member is reduced by applying an electric charge of the opposite polarity by means of a charge eliminating means before the secondary transfer as disclosed in JP-A No. 2006-243333, the problem of an electric charge fluctuation is not dissolved not to obtain high-quality image although the charged amount of the toner image on the intermediate transfer member is reduced.

When a pre-secondary transfer charging means is arranged and adapted to control the output of the pre-secondary transfer charging means in order to maintain the difference between the electric potential of the toner image on the intermediate transfer member and the electric potential of the secondary transfer means for secondarily transferring the toner image onto a transfer medium as disclosed in JP-B 3718045, the charged amount of the toner on the intermediate transfer member increases to degrade the secondary transfer performance because an electric charge is applied with the polarity same as that of the toner.

A transfer apparatus having an intermediate transfer member of a multilayer structure including a conductive layer as disclosed in JP-A 2006-47491 is also accompanied by a problem that the charged amount of the toner on the primary transfer section fluctuates to degrade the secondary transfer performance.

Therefore, the object of the present invention is to provide a transfer apparatus that can uniformize the charged amount of the toner on the intermediate transfer member and ensure a uniform transfer performance over the entire printing surface by means of a simple arrangement for achieving the above object and also an image forming apparatus having such a transfer apparatus.

According to claim 1 of the appended claims of the present invention, the above object is achieved by providing a transfer apparatus including: a primary transfer means arranged corresponding to a plurality of image carriers in order to primarily transfer the toner images on the image carriers; an intermediate transfer member adapted to operate for color superposition by the primary transfer means; a secondary transfer means adapted to operate for secondary transfer of the toner image on the intermediate transfer member onto a transfer medium; and a pre-secondary transfer charging means for electrically charging the pre-secondary transfer toner on the intermediate transfer member with the opposite polarity; the secondary transfer means being adapted to apply a secondary transfer bias to the toner on the intermediate transfer member with the polarity opposite to that of the primary transfer bias applied at the time of primary transfer.

According to claim 2 of the appended claims, in a transfer apparatus according to claim 1, the intermediate transfer embodiment is realized as an intermediate transfer belt.

According to claim 3 of the appended claims, in a transfer apparatus according to claim 1, the intermediate transfer member has a multilayer structure including a conductive layer.

According to claim 4 of the appended claims, in a transfer apparatus according to claim 1, the toner is small size particle toner having a mean particle size between 3 [symbol] m and 5 [symbol] m.

According to claim 5 of the appended claims, in a transfer apparatus according to claim 1, the pre-secondary transfer charging means is a corona charger and a grounded support roller is arranged in the inside of the intermediate transfer member arranged opposite to the corona charger.

According to claim 6 of the appended claims, in a transfer apparatus according to claim 1, the output of the pre-secondary transfer charging means is controlled by the change in the processing rate that varies as a function of the environmental change.

According to claim 7 of the appended claims of the present invention, there is provided an image forming apparatus including: a rotatable image carrier for forming an electrostatic latent image thereon; a developing means for developing the electrostatic toner image by means of toner to form a toner image on the image carrier; an intermediate transfer member for receiving the toner image on the image carrier as transferred thereto; a primary transfer means for applying a primary transfer bias to the intermediate transfer member; a pre-secondary transfer charging means for electrically charging the pre-secondary transfer toner on the intermediate transfer member with the opposite polarity; and a secondary transfer means for transferring the toner image onto a transfer medium by applying a secondary transfer bias with the polarity opposite to the polarity of the primary transfer bias applied for the primary transfer.

According to claim 8 of the appended claims, in an image forming apparatus according to claim 7, the intermediate transfer embodiment is realized as an intermediate transfer belt.

According to claim 9 of the appended claims, in a image forming apparatus according to claim 7, the intermediate transfer member has a multilayer structure including a conductive layer.

According to claim 10 of the appended claims, in an image forming apparatus according to claim 7, the toner is small size particle toner having a mean particle size between 3 [symbol] m and 5 [symbol] m.

According to claim 11 of the appended claims, in a image forming apparatus according to claim 7, the pre-secondary transfer charging means is a corona charger and a grounded support roller is arranged in the inside of the intermediate transfer member arranged opposite to the corona charger.

According to claim 12 of the appended claims, in a image forming apparatus according to claim 7, the output of the pre-secondary transfer charging means is controlled by the change in the processing rate that varies as a function of the environmental change.

According to claim 12 of the appended claims of the present invention, there is provided an image forming method including: forming an electrostatic latent image on an image carrier; developing the electrostatic toner image on the image carrier by a developing means to form a toner image thereon; transferring the toner image on the image carrier onto an intermediate transfer member by a primary transfer means; applying a bias to the toner immediately before secondary transfer by means of a pre-secondary transfer charging means with the polarity opposite to the polarity of electrification of the toner; and applying a secondary transfer bias from a secondary transfer means with the polarity opposite to the polarity of the primary transfer bias to transfer the toner image onto a transfer medium.

### BRIEF DESCRIPTION OF THE DRAWINGS

FIG. 1 is a schematic illustration of the first embodiment of transfer apparatus according to the present invention;

FIG. 2 is a graph illustrating the relationship between the thickness of toner and the charged amount of toner that varies as a function of the toner particle size;

FIG. 3 is a schematic illustration of an image forming apparatus according to the present invention and having the first embodiment of transfer apparatus according to the present invention, showing a principal part thereof;

FIG. 4 is a schematic illustration of the second embodiment of transfer apparatus according to the present invention;

FIG. 5 is a schematic cross sectional view of the intermediate transfer member of the second embodiment of transfer apparatus according to the present invention;

FIG. 6 is a schematic illustration of an image forming apparatus according to the present invention and having the second embodiment of transfer apparatus according to the present invention, showing a principal part thereof; and

FIG. 7 is a schematic illustration of the control unit of a transfer apparatus according to the present invention.

### DETAILED DESCRIPTION OF THE PREFERRED EMBODIMENTS

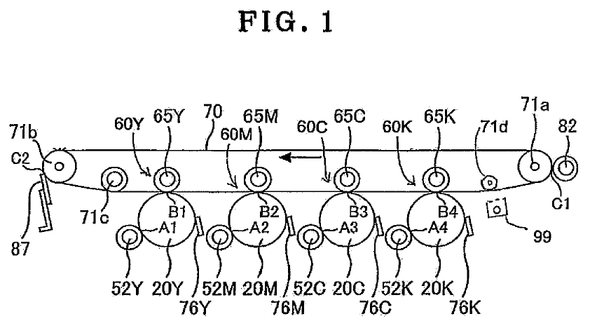

Now, the present invention will be described in greater detail by referring to the accompanying drawings that illustrate preferred embodiments of the invention. FIG. 1 is a schematic illustration of the first embodiment of transfer apparatus according to the present invention.

Referring to FIG. 1, intermediate transfer belt 70 that is an intermediate transfer member operating for primary transfer of the toner images on a plurality of photoreceptors 20 (Y, M, C, K), which are so many image carriers, is an endless belt wound around a drive roller 71a, a follower roller 71b and support rollers 71c, 71d and driven to rotate, while being held in contact with the photoreceptors 20 (Y, M, C, K). Backup rollers 65 (Y, M, C, K) are arranged in the inside of the intermediate transfer belt 70 at positions corresponding to the respective photoreceptors 20 (Y, M, C, K) to apply a primary transfer bias. They operate as so many primary transfer sections B1, B2, B3, B4. Secondary transfer roller 82 is arranged at a position opposite to drive roller 71a located downstream relative to primary transfer units 60 (Y, M, C, K) so as to operate as secondary transfer unit 80.

The toner of the toner images formed on the photoreceptors 20 (Y, M, C, K) shows the polarity of electrification charged by the development units 50 (Y, M, C, K). The toner images formed on the photoreceptors 20 (Y, M, C, K) are moved to respective primary transfer sections B1, B2, B3, B4 as the photoreceptors 20 (Y, M, C, K) rotate and transferred onto the secondary transfer belt 70. At this time, a primary transfer voltage is applied to the primary transfer sections B1, B2, B3, B4 by respective backup rollers 65 (Y, M, C, K) with the polarity opposite to the polarity of electrification of the toner. As a result, the toner images of four colors formed on the respective photoreceptors 20 (Y, M, C, K) are transferred onto and superposed on the intermediate transfer belt 70 to form a full color toner image on the intermediate transfer belt 70.

The full color toner image formed on the intermediate transfer belt 70 gets to the secondary transfer section C1 as the intermediate transfer belt 70 rotates and becomes transferred onto a transfer medium by the secondary transfer unit 80. For the secondary transfer operation, the secondary transfer unit 80 is pressed by the intermediate transfer belt 70 and a secondary transfer voltage showing the polarity opposite to the polarity of electrification of the toner of the full color toner image formed on the intermediate transfer belt 70 is applied to the secondary transfer unit 80. Since the polarity of electrification of the toner at the primary transfer sections B1, B2, B3, B4 is the same as that of electrification of the toner at the secondary transfer section C1 in conventional transfer apparatus, the primary transfer voltage and the secondary transfer voltage show a same polarity.

The charged amount of the toner image after passing through the primary transfer sections B1, B2, B3, B4 for transferring toner images onto the intermediate transfer belt 70 from the photoreceptors 20 (Y, M, C, K) shows variations. The variations of the charged amount of toner occur due to the variations of the quantity of toner that arise when the toner image passes the plurality of photoreceptors 20 (Y, M, C, K) and on the intermediate transfer belt 70 where the toner image has solid areas and half tone areas and also due to the difference of the thickness of the toner that arises between a monochromatic image and superposed images.

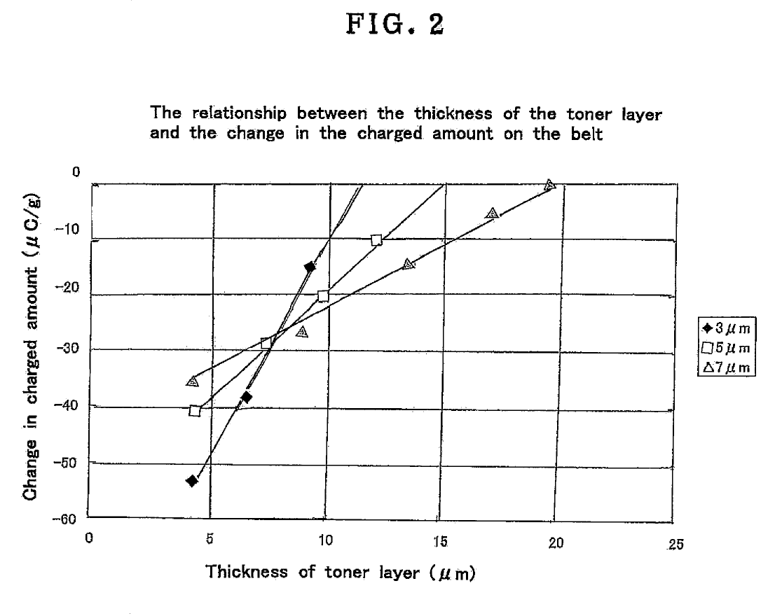

FIG. 2 is a graph illustrating the relationship between the thickness of toner and the charged amount of toner that varies as a function of the toner particle size. The charged amount of toner varies within a range not more than −25 [symbol] C/g when the mean particle size of toner is 7 [symbol] m, whereas the charged amount of toner varies within a range between −10 [symbol] C/g and −40 [symbol] C/g when the mean particle size of toner is 5 [symbol] m and between a range between −15 [symbol] C/g and −60 [symbol] C/g when the means particle size of toner is 3 [symbol] m. The mean particle sizes of toner are volumetric mean particle sizes that were observed by a “Coulter Counter TA-II” or “Coulter Counter Multisizer” equipped with a wet disperser (available from Coulter). Thus, the charged amount of toner on the intermediate transfer belt 70 varies to a large extent and becomes far from uniform when the toner particle size is small.

As the charged amount in the toner image on the intermediate transfer belt 70 varies to a large extent, the toner image contains areas whose transfer performances differ from each other. Secondary transfer becomes unstable to degrade the image quality when the areas whose transfer performances differ from each other are transferred onto a transfer medium under same secondary transfer conditions.

For this reason, according to the present invention, a pre-secondary transfer charging unit 99 is arranged immediately upstream relative to the secondary transfer section C1 for the intermediate transfer belt 70. The pre-secondary transfer charging unit 99 operates to invert the polarity of electrification of toner of the toner images after the primary transfer on the intermediate transfer belt 70 to cancel the variations of the charged amount that arise at the time of primary transfer and uniformize the charged amount.

A corona charger such as a scorotron charger or a corotron charger is employed for the pre-secondary transfer charging unit 99. A grounded support roller 71d is arranged in the inside of the intermediate transfer belt 70 at the position where the scorotron charger is arranged. The scorotron charger has a wire electrode arranged in a shielded case and a grid electrode arranged at an aperture.

When the toner on the intermediate transfer belt 70 has a negative electrification polarity, a voltage of 4.5 kV is applied to the wire electrode while a voltage of +600 V is applied to the grid electrode of the scorotron charger. Then, as a result, it was found that the charged amount of the toner image on the intermediate transfer belt 70 is shifted from −50 [symbol] C/g to +40 [symbol] C/g to invert the polarity. Thus, fluctuation the charged amount that arises at the time of primary transfer can be uniformized by inverting the polarity of the electric charge of the toner image on the intermediate transfer belt 70 after the primary transfer. Under this condition, it is possible to uniformly transfer the entire image by applying a secondary transfer voltage of −20 [symbol] A (−1.6 kV) to the secondary transfer roller 82 with the polarity opposite to the polarity at the time of primary transfer by way of constant current control.

However, the charging efficiency of pre-secondary transfer charging unit 99, which may be typically a scorotron charger, changes as the process speed changes due to changes in the environment such as temperature and relative humidity. If the process speed changes and the pre-secondary transfer charging unit 99 is a scorotron charger, the output voltage of the wire electrode is controlled to accommodate the change.

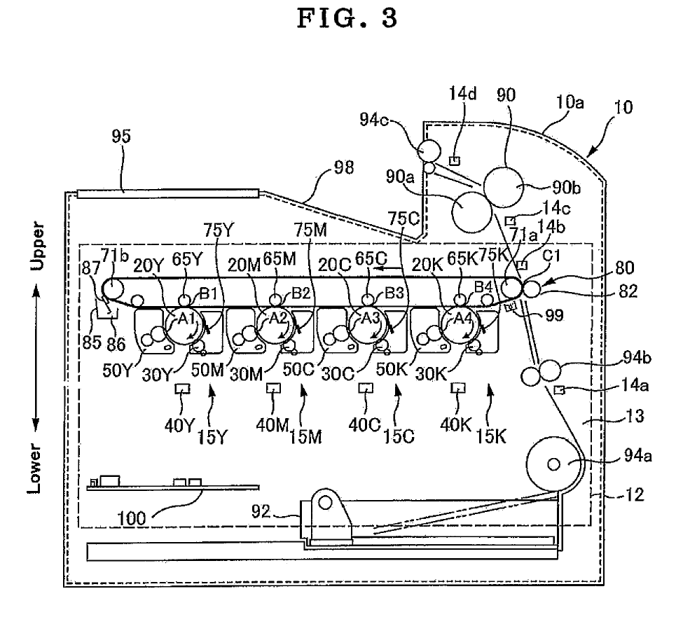

FIG. 3 is a schematic illustration of an image forming apparatus according to the present invention and having the first embodiment of transfer apparatus according to the present invention, showing a principal part thereof. Note that the upward and the downward are indicated by arrows in FIG. 3. For instance, the sheet feed tray 92 is arranged in a lower part of printer 10 and the fixing unit 90 is arranged in an upper part of the printer 10.

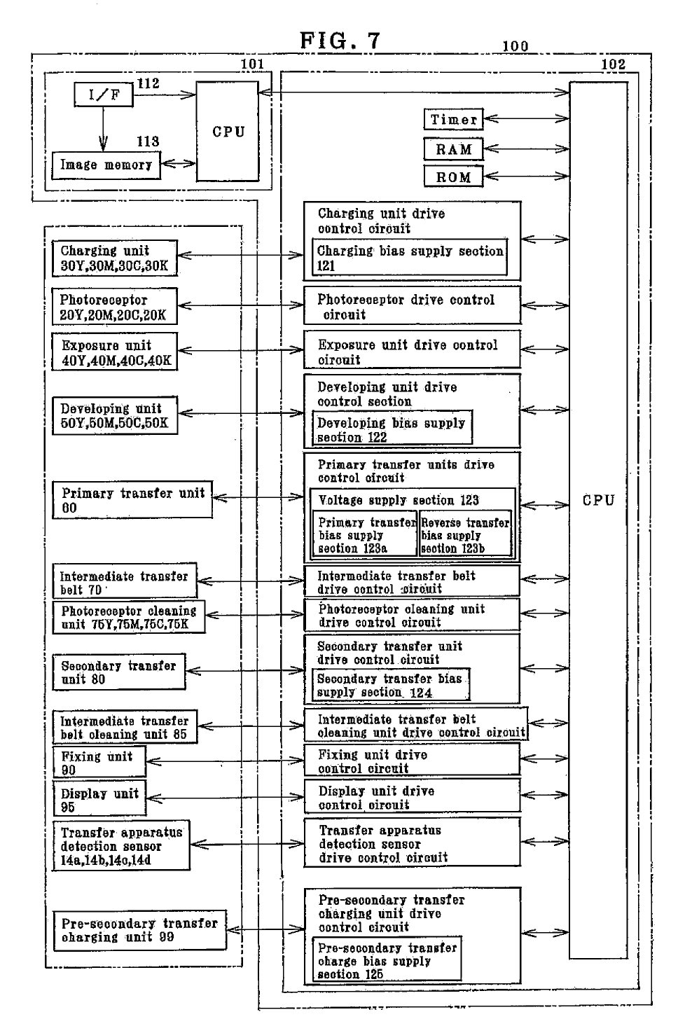

The printer 10 of the first embodiment has four image forming stations 15 (Y, M, C, K), an intermediate transfer belt 70 and a secondary transfer unit 80, a display unit 95, which is a liquid crystal panel and operates as a notification means for the user, and a control unit 100 (see FIG. 7) for controlling those units and also the operation of the printer.

The image forming stations 15 (Y, M, C, K) operate to form toner images in yellow (Y), magenta (M), cyan (C) and black (K) respectively. Since all the image forming stations 15 (Y, M, C, K) have a similar structure, the image forming station 15Y will be described below for all the image forming stations.

As shown in FIG. 3, the image forming station 15Y has a charging unit 30Y, an exposure unit 40Y, a developing unit 50Y, which is as an example of a developing unit, a primary transfer unit 60Y and a photoreceptor cleaning unit 75Y, which are arranged in the described order in the sense of rotation of the photoreceptor 20Y, which is as an example of an image carrier.

The photoreceptor 20Y has a cylindrical base and a photosensitive layer formed on the outer periphery and can rotate around the central axis thereof. In this embodiment, the photoreceptor 20Y rotates clockwise as indicated by an arrow in FIG. 3.

The charging unit 30Y is a device for electrically charging the photoreceptor 20Y. An electrically charged latent image is formed on the photoreceptor 20Y as it is irradiated with a laser beam from an exposure unit (not shown) along light path 40Y. The exposure unit has a semiconductor laser, a polygon mirror and F- [symbol] lens as well as other components and is adapted to irradiate the electrically charged photoreceptor 20Y with a laser beam that is modulated according to the image signal input from a host computer (not shown), which may be a personal computer or a word processor.

The developing unit 50Y is a device for developing the latent image formed on the photoreceptor 20Y by means of yellow (Y) toner.

The primary transfer unit SOY is a device for transferring the yellow toner image formed on the photoreceptor 20Y onto the intermediate transfer belt 70. A full color toner image is formed on the intermediate transfer belt 70 as four toner images are sequentially transferred onto it so as to be laid one on the other by the primary transfer units 60 (Y, M, C, K).

The intermediate transfer belt 70 is an endless belt that is wound around a plurality of support rollers and driven to rotate, contacting the photoreceptors 20 (Y, M, C, K). The intermediate transfer belt 70 of the first embodiment has a single layer structure.

The secondary transfer unit 80 is a device for transferring the monochromatic toner image or the full color toner image formed on the intermediate transfer belt 70 onto a transfer medium such as a sheet of paper, film, cloth or the like.

The fixing unit 90 is a device having a fixing roller 90a and a pressurizing roller 90b and adapted to cause the monochromatic toner image or the full color toner image transferred onto the transfer medium to melt and adhere to the transfer medium as a permanent image.

The photoreceptor cleaning unit 75Y is a device having a rubber-made photoreceptor cleaning blade 76Y (see FIG. 1) that is held in contact with the surface of the photoreceptor 20Y and adapted to scrape off the toner remaining on the photoreceptor 20Y by means of the photoreceptor cleaning blade 76Y after the transfer of the toner image onto the intermediate transfer belt 70 by the primary transfer unit 60.

The control unit 100 has a main controller 101 and a unit controller 102 as shown in FIG. 7. It is adapted to receive image signals and control signals as input and control the other units according to the image signals and the control signals by means of the unit controller 102.

Now, the operation of the printer 10 having the above-described configuration will be described, referring also to other components.

As a image signal and a control signal are input to the main controller 101 of the printer 10 from the host computer (not shown) by way of interface (I/F) 112, the photoreceptors 20 (Y, M, C, K), the developing rollers of the developing units 50 (Y, M, C, K), the intermediate transfer belt 70 and other related members are driven to rotate under the control of the unit controller 102 according to the command from the main controller 101. The photoreceptors 20 (Y, M, C, K) are sequentially electrically charged by the respective charging units 30 (Y, M, C, K) at the respective charging positions while they are being driven to rotate.

As the photoreceptors 20 (Y, M, C, K) are driven to rotate, the areas of the photoreceptors 20 (Y, M, C, K) that are electrically charged eventually get to the respective exposure positions, where latent images are formed in those areas according to yellow Y, magenta M, cyan C and black K image information by the exposure units 40 (Y, M, C, K).

As the photoreceptors 20 (Y, M, C, K) are driven to rotate further, the latent images formed on the photoreceptors 20 (Y, M, C, K) get to the respective developing positions and developed by the respective developing units 50 (Y, M, C, K). As a result, toner images are formed on the photoreceptors 20 (Y, M, C, K).

As the photoreceptors 20 (Y, M, C, K) are driven to rotate further, the toner images formed on the photoreceptors 20 (Y, M, C, K) then get to the respective primary transfer sections B1, B2, B3, B4 and transferred onto the intermediate transfer belt 70 respectively by the primary transfer units 60 (Y, M, C, K). At this time, a primary transfer voltage showing the polarity opposite to the polarity of electrification of toner is applied to each of the primary transfer units 60 (Y, M, C, K). As a result, the toner images of the four colors formed on the respective photoreceptors 20 (Y, M, C, K) are transferred onto the intermediate transfer belt 70 so as to be laid one on the other so that a full color toner image is formed on the intermediate transfer belt 70.

Rollers are arranged along the inner surface of the intermediate transfer belt 70 and the intermediate transfer belt 70 is driven to rotate as drive force is transmitted to it typically from a motor (not shown).

The full color toner image formed on the intermediate transfer belt 70 moves to the secondary transfer position as the intermediate transfer belt 70 is driven to rotate further, while the polarity of electrification of the toner image on the intermediate transfer belt 70 is turned opposite by the pre-secondary transfer charging unit 99 arranged immediately upstream relative to the secondary transfer position. Thereafter, the full color toner image is transferred onto a transfer medium such as a sheet of paper by the secondary transfer unit 80. Since the polarity of electrification of the toner image on the intermediate transfer belt 70 is turned opposite by the pre-secondary transfer charging units 99, a secondary transfer voltage is applied to the secondary transfer unit 80 for the secondary transfer with the polarity opposite to the polarity of the primary transfer voltage applied at the time of the primary transfer. The transfer medium is fed from the sheet feed tray 92 to the secondary transfer unit 80 by way of a sheet feed roller 94a and a registration roller 94b.

After the full color toner image is transferred onto the transfer medium by the secondary transfer unit 80, the intermediate transfer belt 70 is further driven to rotate counterclockwise and the toner remaining on the surface of the intermediate transfer belt 70 is removed by an intermediate transfer belt cleaning blade 87. The intermediate transfer belt cleaning blade 87 is a blade made of rubber, which is urethane rubber showing a hardness of JIS-A70°. While the intermediate transfer belt 70 has a width of 324 mm, the intermediate transfer belt cleaning blade 87 has a width of 317 mm. The intermediate transfer belt cleaning blade 87 is pressed against and held in contact with the intermediate transfer belt 70 with linear pressure of 50 gf/cm. A mechanism for separating the intermediate transfer belt cleaning blade 87 from the intermediate transfer belt 70 whenever necessary may be provided.

The full color toner image transferred onto the transfer medium is caused to melt and adhere to the transfer medium as it is heated and pressurized by the fixing unit 90. After passing through the fixing unit 90, the transfer medium is discharged by a sheet discharge roller 94c.

On the other hand, after passing the primary transfer sections B1, B2, B3, B4, the electric charges of the photoreceptors 20 (Y, M, C, K) are removed by respective charge eliminating units (not shown) and the toner adhering to the surfaces of the photoreceptors 20 (Y, M, C, K) are scraped off by the respective photoreceptor cleaning blades 76 (Y, M, C, K) supported by the respective photoreceptor cleaning units 75 (Y, M, C, K) to make the photoreceptors 20 (Y, M, C, K) ready for the next operation of forming latent images. The scraped off toner is collected by remaining toner collecting sections that the photoreceptor cleaning units 75 (Y, M, C, K) respectively have.

Now, the configuration of the control unit 100 will be described below by referring to FIG. 7. The control unit 100 is connected to the host computer by way of the interface 112 and has an image memory 113 for storing the image signals input from the host computer. The unit controller 102 is electrically connected to the units (the charging units 30 (Y, M, C, K), the photoreceptor units 20 (Y, M, C, K), the exposure units 40 (Y, M, C, K), the developing units 50, the primary transfer units 60 (Y, M, C, K), the intermediate transfer belt 70, the photoreceptor cleaning units 75 (Y, M, C, K), the secondary transfer unit 80, the intermediate transfer belt cleaning unit 85, the fixing unit 90, the display unit 95 and transfer medium detection sensors 14 (a, b, c, d)) so that it detects the conditions of the units and controls the units as it receives the signals from the sensors of the units according to the signal input from the main controller 101.

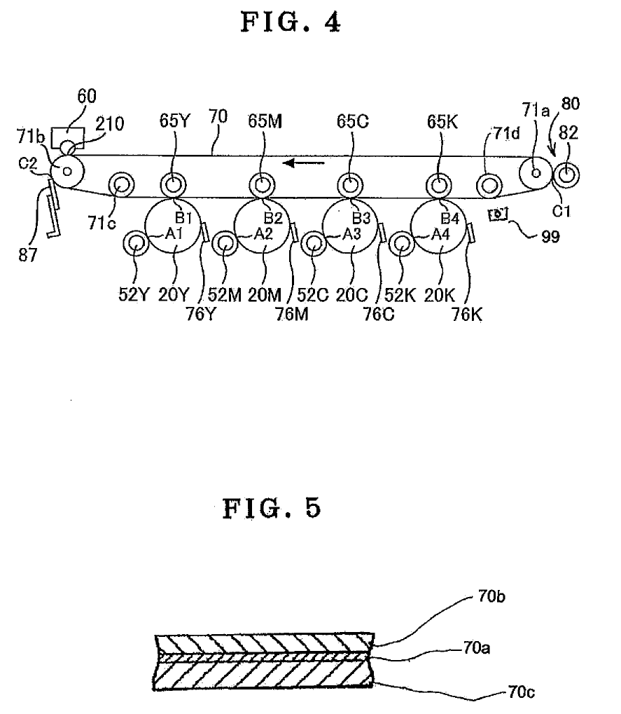

FIG. 4 is a schematic illustration of the second embodiment of transfer apparatus according to the present invention. The components of the second embodiment same as those of the first embodiment are denoted respectively by the same reference symbols. The transfer apparatus of the second embodiment has a configuration same as the first embodiment except that the intermediate transfer member thereof is an intermediate transfer belt having a multilayer structure including a conductive layer. Therefore, only the difference will be described below.

The intermediate transfer member that is an intermediate transfer belt 70 having a multilayer structure including a conductive layer for transferring the toner images on a plurality of image carriers, which are photoreceptors 20 (Y, M, C, K), is an endless belt wound around a drive roller 71a, a follower roller 71b, support rollers 71c, 71d that are grounded. It is driven to rotate, while being held in contact with the photoreceptors 20 (Y, M, C, K).

As shown in FIG. 5, the intermediate transfer belt 70 has a multilayer structure including a conductive layer 70a made of a conductor such as a metal thin film, a resistance layer 70b formed on the conductive layer 70a so as to be pressed by the photoreceptors 20 (Y, M, C, K) by dispersing a conducting agent into insulating resin so as to show a regulated volume resistivity and an insulating base 70c formed under the conductive layer 70a and made of insulating resin.

The resistance layer 70b is removed by belt-like parts along the lateral edges of the intermediate transfer belt 70 to expose belt-like parts of the conductive layer 70a. The primary transfer units 60 are adapted to apply a primary transfer voltage to the intermediate transfer belt 70 as electrode roller 210 is brought into contact with the belt-like parts of the conductive layer 70a and the follower roller 71b of the intermediate transfer belt 70 operates as backup roller.

With the above-described arrangement, the pressure-contact sections B1, B2, B3, B4 (the primary transfer sections) where the photoreceptors 20 (Y, M, C, K) are held in contact with the intermediate transfer belt 70 show a uniform electric potential to improve the transfer performance. Grounded backup rollers 65 (Y, M, C, K) are arranged in the inside of the intermediate transfer belt 70 at positions corresponding to the respective photoreceptors 20 (Y, M, C, K). The secondary transfer unit 80 includes a secondary transfer roller 82 for applying a secondary transfer bias is arranged at a position located opposite to the drive roller 71a that is arranged downstream relative to the primary transfer sections B1, B2, B3, B4.

The toner of the toner images formed on the photoreceptors 20 (Y, M, C, K) shows the polarity of electrification charged by the development units 50 (Y, M, C, K). As the photoreceptors 20 (Y, M, C, K) are driven to rotate, the toner images formed on the photoreceptors 20 (Y, M, C, K) respectively get to the primary transfer sections B1, B2, B3, B4 and are transferred onto the intermediate transfer belt 70. At this time, a primary transfer voltage is applied to the primary transfer sections B1, B2, S3, B4 by the electrode roller 210 with the polarity opposite to the polarity of electrification of the toner. As a result, the toner images of the four colors formed on the respective photoreceptors 20 (Y, M, C, K) are transferred onto the intermediate transfer belt 70 so as to be laid one on the other. Thus, a full color toner image is formed on the intermediate transfer belt 70.

The full color toner image formed on the intermediate transfer belt 70 gets to the secondary transfer section C1 as the intermediate transfer belt 70 rotates and becomes transferred onto a transfer medium by the secondary transfer unit 80. For the secondary transfer operation, the secondary transfer unit 80 is pressed by the intermediate transfer belt 70 and a secondary transfer voltage showing the polarity opposite to the polarity of electrification of toner of the full color toner image formed on the intermediate transfer belt 70 is applied to the secondary transfer unit 80. Since the polarity of electrification of toner at the primary transfer sections B1, B2, B3, B4 is the same as the polarity of electrification of toner at the secondary transfer section C1 in conventional transfer apparatus, the primary transfer voltage and the secondary transfer voltage show a same polarity.

The charged amount of the toner image after passing through the primary transfer sections B1, B2, B3, B4 for transferring toner images onto the intermediate transfer belt 70 from the photoreceptors 20 (Y, M, C, K) shows variations. The variations of the charged amount of toner occur due to the variations of the amount of toner that arise when the toner image passes the plurality of photoreceptors 20 (Y, M, C, K) and on the intermediate transfer belt 70 where the toner image has solid areas and half tone areas and also due to the difference of the thickness of the toner that arises between a monochromatic image and superposed images.

FIG. 3 is a graph illustrating the relationship between the thickness of toner and the charged amount of toner that varies as a function of the toner particle size. The electric charge of toner varies within a range not more than −25 [symbol] C/g when the mean particle size of toner is 7 [symbol] m, whereas the charged amount of toner varies within a range between −10 [symbol] C/g and −40 [symbol] C/g when the mean particle size of toner is 5 [symbol] m and between a range between −15 [symbol] C/g and −60 [symbol] C/g when the means particle size of toner is 3 [symbol] m. The mean particle sizes of toner are volumetric mean particle sizes that were observed by a “Coulter Counter TA-II” or “Coulter Counter Multisizer” equipped with a wet disperser (available from Coulter). Thus, the charged amount of toner on the intermediate transfer belt 70 varies to a large extent and fluctuates when the toner particle size is small.

As the charged amount in the toner image on the intermediate transfer belt 70 varies to a large extent, the toner image contains areas whose transfer performances differ from each other. Secondary transfer becomes unstable to degrade the image quality when the areas whose transfer performances differ from each other are transferred onto a transfer medium under same transfer conditions.

For this reason, according to the present invention, a pre-secondary transfer charging unit 99 is arranged immediately upstream relative to the secondary transfer section C1 for the intermediate transfer belt 70. The pre-secondary transfer charging unit 99 operates to invert the polarity of electrification of toner of the toner images after the primary transfer on the intermediate transfer belt 70 to cancel the variations of the charged amount that arise at the time of primary transfer and uniformize the charged amount.

A corona charger such as a scorotron charger or a corotron charger is employed for the pre-secondary transfer charging unit 99. The scorotron charger has a wire electrode arranged in a shielded case and a grid electrode arranged at an aperture. A grounded backup roller 71d is arranged in the inside of the intermediate transfer belt 70 at the position where the scorotron charger is arranged.

When the toner on the intermediate transfer belt 70 has a negative electrification polarity, a voltage of 4.5 kV is applied to the wire electrode while a voltage of +600 V is applied to the grid electrode of the scorotron charger. Then, as a result, it was found that the charge amount of the toner image on the intermediate transfer belt 70 is shifted from −50 [symbol] C/g to +40 [symbol] C/g to invert the polarity. Thus, fluctuation the charged amount that arises at the time of primary transfer can be uniformized by inverting the polarity of electrification of the toner image on the intermediate transfer belt 70 after the primary transfer. Additionally, since the toner that is electrically charged to the opposite polarity by the primary transfer bias and the pre-secondary transfer charging unit 99 is made to show the same polarity, force trying to move the toner away from the secondary transfer belt 70 is applied to it immediately before the secondary transfer. Under this condition, it is possible to uniformly and efficiently transfer the entire image by applying a secondary transfer voltage of −20 [symbol] A (−1.6 kV) to the secondary transfer roller 82 with the polarity opposite to the polarity at the time of primary transfer by way of constant current control.

However, the charging efficiency of pre-secondary transfer charging unit 99, which may be typically a scorotron charger, changes as the process speed changes due to changes in the environment such as temperature and relative humidity. If the process speed changes and the pre-secondary transfer charging unit 99 is a scorotron charger, the output voltage of the wire electrode is controlled to accommodate the change.

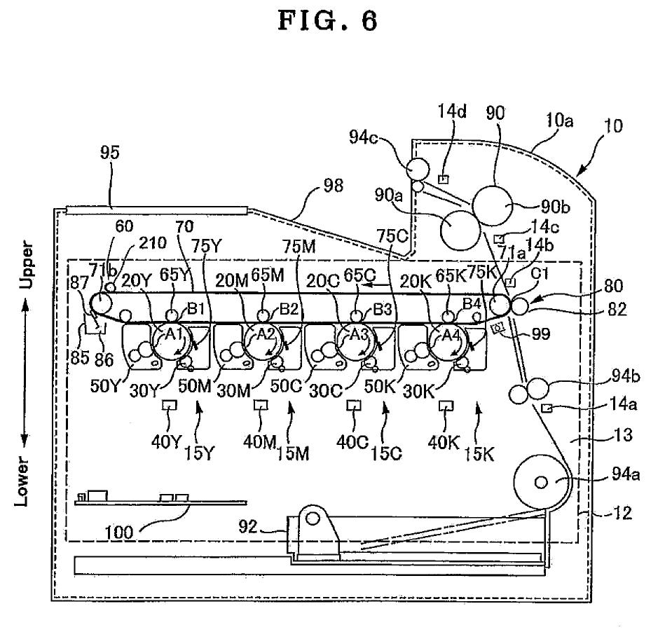

FIG. 6 is a schematic illustration of an image forming apparatus according to the present invention and having the second embodiment of transfer apparatus according to the present invention, showing a principal part thereof. In FIG. 6, the components same as those of the first embodiment are denoted respectively by the same reference symbols. Since the image forming apparatus of the second embodiment is similar to the image forming apparatus of the first embodiment except that the intermediate transfer member is an intermediate transfer belt that is made to have a multilayer structure including a conductive layer, only the part of the configuration difference from that of the first embodiment will be described below.

The intermediate transfer belt 70 is an endless belt wound around a plurality of support rollers and driven to rotate, while being held in contact with the photoreceptors 20 (Y, M, C, K). As shown in FIG. 2, the intermediate transfer belt 70 has a multilayer structure including a conductive layer 70a, a resistance layer 70b formed on the conductive layer 70a so as to be pressed by the photoreceptors 20 (Y, M, C, K) and an insulating base 70c formed under the conductive layer 70a. The resistance layer 70b is removed by belt-like parts along the lateral edges of the intermediate transfer belt 70 to expose belt-like parts of the conductive layer 70a. The primary transfer units 60 are adapted to apply a primary transfer voltage to the intermediate transfer belt 70 as electrode roller 210 is brought into contact with the belt-like parts of the conductive layer 70a and the follower roller 71b operates as backup roller. In the case of the photoreceptor 20Y, as the photoreceptor 20Y is brought into contact with the intermediate transfer belt 70 at the primary transfer sections B1, the yellow toner image is transferred onto the intermediate transfer belt 70 for primary transfer. When four toner images are sequentially transferred so as to be laid one on the other, a full color toner image is formed on the intermediate transfer belt 70.

What is claimed is:

1. A transfer apparatus comprising:
primary transfer means arranged corresponding to a plurality of image carriers in order to primarily transfer the toner images on the image carriers;
an intermediate transfer member adapted to operate for color superposition by the primary transfer means;
secondary transfer means adapted to operate for secondary transfer of the toner image on the intermediate transfer member onto a transfer medium; and
pre-secondary transfer charging means for electrically charging the pre-secondary transfer toner on the intermediate transfer member with the opposite polarity;
the secondary transfer means being adapted to apply a secondary transfer bias to the toner on the intermediate transfer member with the polarity opposite to that of the primary transfer bias applied at the time of primary transfer.

2. The apparatus according to claim 1, wherein the intermediate transfer embodiment is realized as an intermediate transfer belt.

3. The apparatus according to claim 1, wherein the intermediate transfer member has a multilayer structure including a conductive layer.

4. The apparatus according to claim 1, wherein the toner is small size particle toner having a mean particle size between 3 [symbol] m and 5 [symbol] m.

5. The apparatus according to claim 1, wherein the pre-secondary transfer charging means is a corona charger and a grounded support roller is arranged in the inside of the intermediate transfer member arranged opposite to the corona charger.

6. The apparatus according to claim 1, wherein the output of the pre-secondary transfer charging means is controlled by the change in the processing rate that varies as a function of the environmental change.

7. An image forming apparatus comprising:
a rotatable image carrier for forming an electrostatic latent image thereon;
developing means for developing the electrostatic toner image by means of toner to form a toner image on the image carrier;
an intermediate transfer member for receiving the toner image on the image carrier as transferred thereto;
primary transfer means for applying a primary transfer bias to the intermediate transfer member;
pre-secondary transfer charging means for electrically charging the pre-secondary transfer toner on the intermediate transfer member with the opposite polarity; and
secondary transfer means for transferring the toner image onto a transfer medium by applying a secondary transfer bias with the polarity opposite to the polarity of the primary transfer bias applied for the primary transfer.

8. The apparatus according to claim 7, wherein the intermediate transfer member is realized as an intermediate transfer belt.

9. The apparatus according to claim 7, wherein the intermediate transfer member has a multilayer structure including a conductive layer.

10. The apparatus according to claim 7, wherein the toner is small size particle toner having a volumetric mean particle size between 3 [symbol] m and 5 [symbol] m.

11. The apparatus according to claim 7, wherein the pre-secondary transfer charging means is a corona charger and a grounded support roller is arranged in the inside of the intermediate transfer member arranged opposite to the corona charger.

12. The apparatus according to claim 7, wherein the output of the pre-secondary transfer charging means is controlled by the change in the processing rate that varies as a function of the environmental change.

13. An image forming method comprising:
forming an electrostatic latent image on an image carrier;
developing the electrostatic latent image on the image carrier by a developing means to form a toner image thereon;
transferring the toner image on the image carrier onto an intermediate transfer member by a primary transfer means;
applying a bias to the toner immediately before secondary transfer by means of a pre-secondary transfer charging means with the polarity opposite to the polarity of electrification of the toner; and
applying a secondary transfer bias from a secondary transfer means with the polarity opposite to the polarity of the primary transfer bias to transfer the toner image onto a transfer medium.
